(19) United States
(12) Patent Application Publication
(10) Pub. No.: US 2025/0329065 A1
(43) Pub. Date: Oct. 23, 2025

(54) IMAGE GENERATION APPARATUS, IMAGE GENERATION METHOD, AND NON-TRANSITORY COMPUTER-READABLE MEDIUM

(71) Applicant: NEC Corporation, Tokyo (JP)

(72) Inventors: Shota KIZUKURI, Tokyo (JP); Takahisa YUTOKU, Tokyo (JP); Daisuke FUKASAWA, Tokyo (JP); Satoru YAMADA, Tokyo (JP); Masahiro WATANABE, Tokyo (JP); Hiroshi KAJIKAWA, Tokyo (JP); Yoshihiko KOIZUMI, Tokyo (JP)

(73) Assignee: NEC Corporation, Tokyo (JP)

(21) Appl. No.: 19/171,735

(22) Filed: Apr. 7, 2025

(30) Foreign Application Priority Data
Apr. 18, 2024 (JP) 2024-067248

(51) Int. Cl. G06T 11/00; G06F 40/30

(52) U.S. Cl. CPC G06T 11/00; G06F 40/30

(57) ABSTRACT

An image generation apparatus according to the present disclosure acquires sentence data, extracts a plurality of keywords from the sentence data, and generates an image related to the sentence data by inputting the plurality of keywords to an image generation model.

### INCORPORATION BY REFERENCE

This application is based upon and claims the benefit of priority from Japanese patent application No. 2024-067248, filed on Apr. 18, 2024, the disclosure of which is incorporated herein in its entirety by reference.

### TECHNICAL FIELD

The present disclosure relates to an image generation apparatus, an image generation method, and a non-transitory computer-readable medium.

### BACKGROUND ART

Techniques for generating an image from a text have been developed. For example, Patent Literature 1 discloses a system that generates a prompt based on one or more tags selected by a user, and automatically generates a background image of an illustration by using the prompt.

### CITATION LIST

### Patent Literature

[Patent Literature 1] Japanese Patent No. 7398723

### SUMMARY

In the system according to Patent Literature 1, a user needs to select, from among tags prepared in advance, features of the background image to be generated. The present disclosure has been made in view of this problem, and an example objective of the present disclosure is to provide a novel technique for generating an image from a text.

An example advantage according to the present disclosure is that it is possible to provide a novel technique for generating an image from a text.

In a first example aspect according to the present disclosure, an image generation apparatus includes at least one memory that is configured to store instructions and at least one processor that is configured to execute the instructions to: acquire sentence data; extract a plurality of keywords from the sentence data; and generate an image related to the sentence data by inputting the plurality of keywords to an image generation model.

In a second example aspect according to the present disclosure, an image generation method is executed by one or more computers, comprising: acquiring sentence data; extracting a plurality of keywords from the sentence data; and generating an image related to the sentence data by inputting the plurality of keywords to an image generation model.

In a third example aspect according to the present disclosure, a program causes one or more computers to execute: acquiring sentence data; extracting a plurality of keywords from the sentence data; and generating an image related to the sentence data by inputting the plurality of keywords to an image generation model.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating an overview of an image generation apparatus;

FIG. 2 is a block diagram illustrating a functional configuration of the image generation apparatus;

FIG. 3 is a block diagram illustrating a hardware configuration of a computer that achieves the image generation apparatus; and

FIG. 4 is a flowchart illustrating a flow of processing being executed by the image generation apparatus.

### EXAMPLE EMBODIMENT

Example embodiments of the present disclosure will be described in detail hereinafter with reference to the drawings. In the drawings, the same or equivalent elements are denoted by the same reference numerals, and redundant descriptions are omitted as necessary for clarity of description. Unless otherwise specified, values set in advance such as a predetermined value and a threshold value are stored in advance in a storage apparatus or the like that can be accessed from an apparatus that uses the value. Further, unless otherwise specified, the storage unit may be constituted by any number, including one, of storage apparatuses.

### Overview

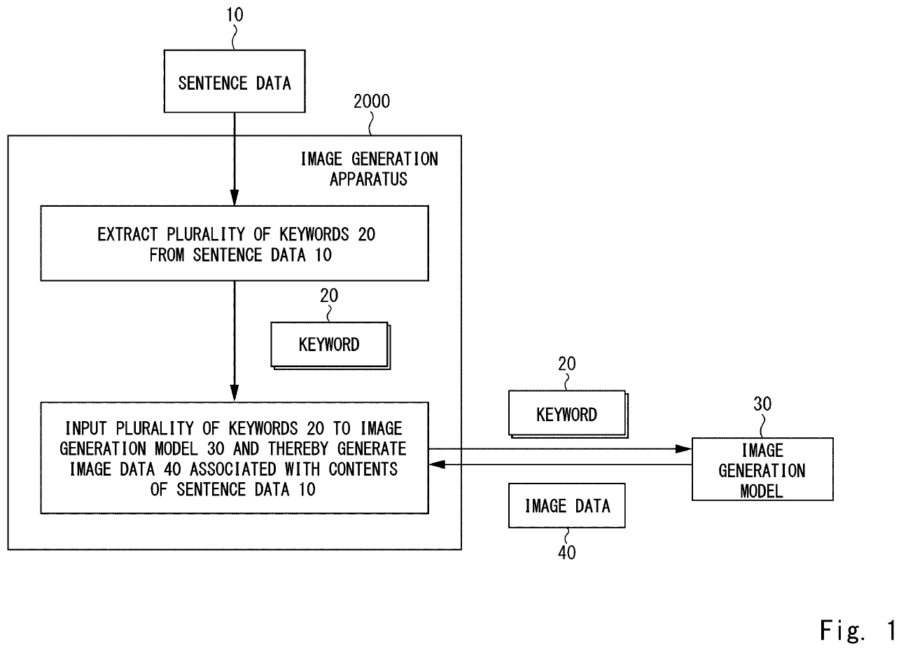

FIG. 1 is a diagram illustrating an overview of an image generation apparatus 2000. The operation of the image generation apparatus 2000 illustrated in FIG. 1 is an example for the purpose of facilitating understanding of the image generation apparatus 2000. Operations that can be performed by the image generation apparatus 2000 are not limited to the operation illustrated in FIG. 1.

The image generation apparatus 2000 generates image data 40, which is an image associated with the content of sentence data 10. The sentence data 10 are text data representing any sentence related to a specific topic (hereinafter, target topic). For example, the target topic is cyber security or the like. When the target topic is cyber security, for example, the sentence data 10 represents an explanation or a security report about a malicious attack such as phishing mail.

Herein, the image generation apparatus 2000 may be configured to handle only one topic (for example, cyber security only) as a target topic, or may be configured to be able to select a target topic from among a plurality of topics. In the latter case, a topic to be handled as a target topic is selected by some kind of method in the image generation apparatus 2000. A method for selecting a target topic will be described later.

In order to generate the image data 40 from the sentence data 10, for example, the image generation apparatus 2000 operates as follows. First, the image generation apparatus 2000 acquires the sentence data 10. Next, the image generation apparatus 2000 extracts a plurality of keywords 20 from the sentence data 10. The keyword 20 is a word related to the target topic. For example, when the target topic is cyber security, words related to cyber security are extracted as the keywords 20.

The image generation apparatus 2000 inputs the plurality of keywords 20 to an image generation model 30. The image generation model 30 is trained in advance to output one or more pieces of image data in response to input of a plurality of words. The image data being output from the image generation model 30 is an image in which information associated with the plurality of input words is visualized.

In a case where the image generation model 30 is configured to output a plurality of pieces of image data, the plurality of pieces of image data are, for example, time-series image data. The time-series image data may be video data or may not be video data. In the latter case, for example, the plurality of pieces of image data represents changes in a situation, the flow of a procedure, or the like in time series, in a manner similar to a picture-story show. In a case where the image generation model 30 is configured to output time-series image data, the image generation apparatus 2000 can acquire time-series image data 40 in which information associated with the plurality of keywords 20 is visualized.

Note that the image generation model 30 may be provided inside the image generation apparatus 2000 or outside the image generation apparatus 2000. In the latter case, the image generation model 30 may be a special-purpose image generation model prepared for generating the image data 40, or may be a general- purpose image generation model that can be used for purposes other than the generation of the image data 40.

### Example of Advantageous Effects

According to the image generation apparatus 2000, the plurality of keywords 20 are extracted from the sentence data 10, and the image data 40 are generated using the extracted plurality of keywords 20. As described above, according to the image generation apparatus 2000, a novel technique for generating an image from text, which is not disclosed in Patent Literature 1, is provided.

Furthermore, a user who uses the system of Patent Literature 1 needs to select a tag to be provided to a model by oneself. On the other hand, since the keyword 20 is automatically extracted from the sentence data 10 in the image generation apparatus 2000, a user of the image generation apparatus 2000 does not need to select a keyword to be provided to the image generation model 30 by oneself. Therefore, the image generation apparatus 2000 can reduce the time and effort of the user required to generate an image.

In the system of Patent Literature 1, a tag to be provided to a model can be selected only from predetermined tags. On the other hand, any sentence may be provided to the image generation apparatus 2000. As described above, the image generation apparatus 2000 can accept input of a wider range of contents, and thus is highly convenient.

The image generation apparatus 2000 according to the present example embodiment will be described in more detail hereinafter.

### Example of Functional Configuration

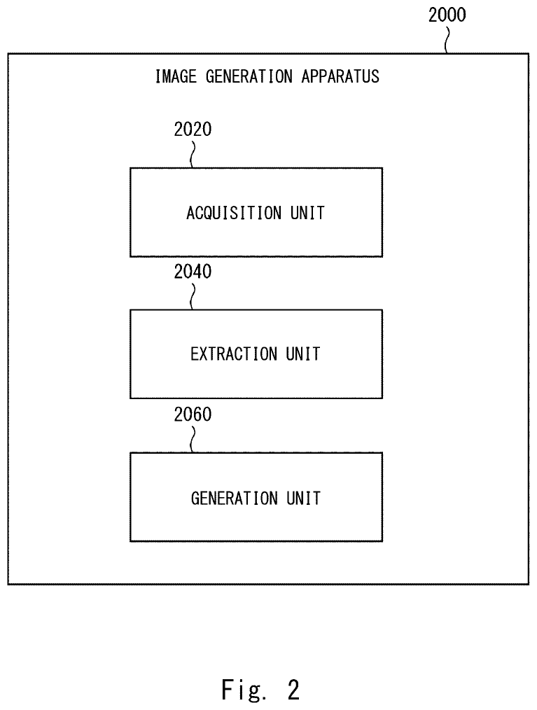

FIG. 2 is a block diagram illustrating a functional configuration of the image generation apparatus 2000. The image generation apparatus 2000 includes an acquisition unit 2020, an extraction unit 2040, and a generation unit 2060. The acquisition unit 2020 acquires the sentence data 10. The extraction unit 2040 extracts a plurality of keywords 20 from the sentence data 10. The generation unit 2060 generates image data 40 by inputting the plurality of keywords 20 to the image generation model 30.

### Example of Hardware Configuration

Each functional component of the image generation apparatus 2000 may be implemented by hardware (for example, a hardwired electronic circuit or the like) that implements each functional component, or may be implemented by a combination of hardware and software (for example, a combination of an electronic circuit and a program that controls the electronic circuit or the like). A case where each functional component of the image generation apparatus 2000 is implemented by a combination of hardware and software will be further described hereinafter.

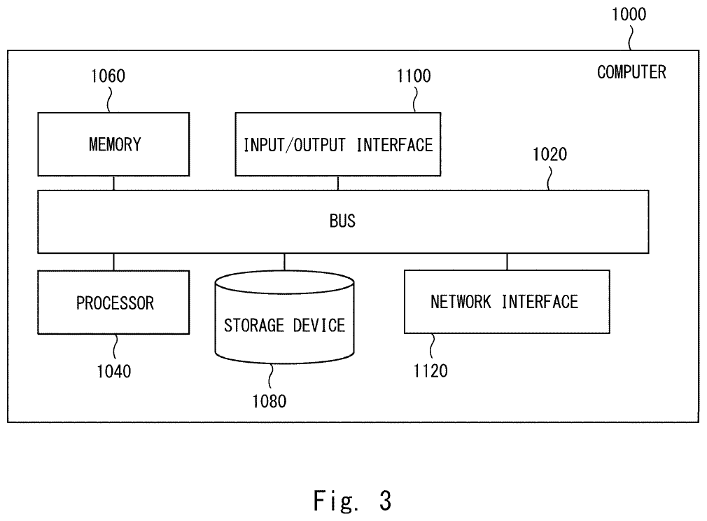

FIG. 3 is a block diagram illustrating a hardware configuration of a computer 1000 configured to implement the image generation apparatus 2000. The computer 1000 may be any computer. For example, the computer 1000 is a stationary computer such as a personal computer (PC) or a server machine. In another example, the computer 1000 is a portable computer such as a smartphone or a tablet terminal. The computer 1000 may be a special-purpose computer designed to implement the image generation apparatus 2000, or may be a general-purpose computer.

For example, by installing a predetermined application on the computer 1000, each function of the image generation apparatus 2000 is implemented by the computer 1000. The above-described application is constituted by a program for implementing each functional component of the image generation apparatus 2000. Note that the method for acquiring the program may be any method. For example, the program can be acquired from a storage medium in which the program is stored. The storage medium in which the program is stored is any storage medium such as a digital versatile disk (DVD) or a universal serial bus (USB) memory. In another example, the program can be acquired by downloading the program from a server apparatus that manages a storage apparatus in which the program is stored.

The computer 1000 includes a bus 1020, a processor 1040, a memory 1060, a storage device 1080, an input and output (I/O) interface 1100, and a network interface 1120. The bus 1020 is a data transmission path through which the processor 1040, the memory 1060, the storage device 1080, the I/O interface 1100, and the network interface 1120 transmit and receive data to and from one another. However, the method for connecting the processors 1040 and the like to one another is not limited to bus connection.

The processor 1040 is a variety of processors such as central processing units (CPUs), graphics processing units (GPUs), and field-programmable gate arrays (FPGAs). The memory 1060 is a primary storage component implemented by using a random access memory (RAM) or the like. The storage device 1080 is a secondary storage component implemented by using a hard disk, a solid state drive (SSD), a memory card, a read only memory (ROM), or the like.

The I/O interface 1100 is an interface for connecting the computer 1000 and an input device or an output device. For example, an input device such as a keyboard or an output device such as a display device is connected to the I/O interface 1100.

The network interface 1120 is an interface for connecting the computer 1000 to a network. The network may be a local area network (LAN) or a wide area network (WAN).

The storage device 1080 stores a program (a program for implementing the above-described application) for implementing each functional component of the image generation apparatus 2000. The processor 1040 reads the program into the memory 1060 and executes the program, thereby implementing each of the functional components of the image generation apparatus 2000.

The image generation apparatus 2000 may be implemented by a single computer 1000 or may be implemented by a plurality of computers 1000. In the latter case, the configuration of each computer 1000 need not be the same, but may be different.

### Flow of Processes

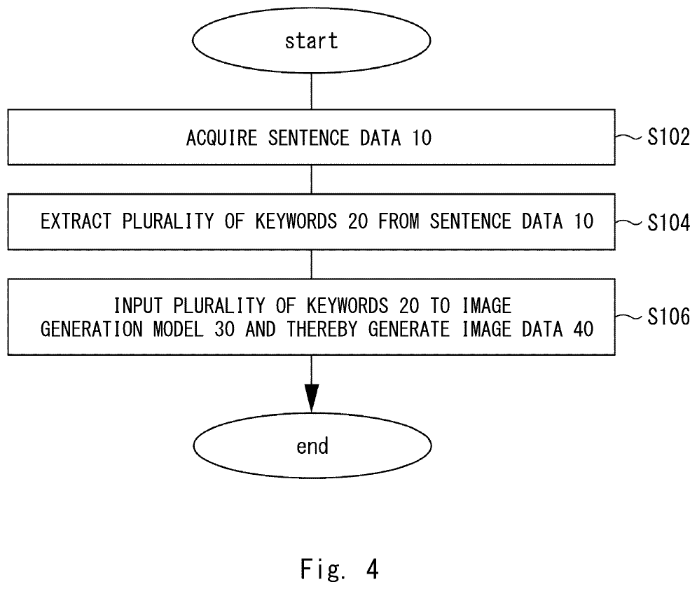

FIG. 4 is a flowchart illustrating a flow of processes being executed by the image generation apparatus 2000. The acquisition unit 2020 acquires the sentence data 10 (S102). The extraction unit 2040 extracts a plurality of keywords 20 from the sentence data 10 (S104). The generation unit 2060 generates image data 40 by inputting the plurality of keywords 20 to the image generation model 30 (S106).

### Acquisition of Sentence Data 10: S102

The acquisition unit 2020 acquires the sentence data 10 (S102). The acquisition unit 2020 acquires the sentence data 10 in various ways. For example, the acquisition unit 2020 provides a user of the image generation apparatus 2000 with an input screen on which sentences can be input. In such a case, the acquisition unit 2020 acquires text data representing sentences that is input to the input screen as the sentence data 10. Instead of inputting text data, the input screen may be configured to be capable of designating a file (for example, a document file of any format) including text data representing sentences. In such a case, the acquisition unit 2020 acquires the text data included in the file designated on the input screen as the sentence data 10.

In another example, the sentence data 10 is stored in advance in any storage unit in a manner accessible from the image generation apparatus 2000. The acquisition unit 2020 acquires the sentence data 10 by reading the sentence data 10 from the storage unit.

In another example, the image generation apparatus 2000 may be configured to operate in cooperation with other applications. In such a case, the sentence data 10 may be input to the image generation apparatus 2000 from the other applications.

Note that, in a case where sentences of various languages may be input to the image generation apparatus 2000, the image generation apparatus 2000 may translate the input sentences into a specific language and handle the sentences acquired by the translation as the sentence data 10. By doing so, it is possible to narrow down the target of subsequent processing, such as keyword extraction, to sentences in a specific language.

For example, it is assumed that the image generation apparatus 2000 handles English sentences as the sentence data 10, while sentence in any language such as Japanese or French can also be input on the input screen. In such a case, the acquisition unit 2020 translates the input sentences into English, and handles the English sentences acquired through translation as the sentence data 10.

### Extraction of Keyword 20: S104

The extraction unit 2040 extracts a plurality of keywords 20 from the sentence data 10 (S104). Specifically, the extraction unit 2040 extracts words related to the target topic from the sentence data 10.

As described above, the image generation apparatus 2000 may be configured to handle only one topic as a target topic, or may be configured to select a target topic from among a plurality of topics. First, the former case will be described.

For example, the extraction unit 2040 uses information (hereinafter, keyword information) in which a plurality of words related to the target topic are defined as keywords. Specifically, the extraction unit 2040 extracts words indicated in the keyword information from the sentence data 10, and handles the extracted words as the keywords 20. The keyword information is stored in advance in any storage unit in a manner that can be acquired from the image generation apparatus 2000.

In another example, the extraction unit 2040 uses a pre-trained machine learning model (hereinafter, keyword extraction model). The keyword extraction model is trained in advance to extract, in response to sentences being input, keywords related to the target topic from the sentences. The extraction unit 2040 inputs the sentence data 10 to the keyword extraction model. Then, the extraction unit 2040 handles each keyword extracted by the keyword extraction model as the keyword 20.

In a case where the image generation apparatus 2000 is configured to be capable of selecting a target topic, the above-described keyword information or keyword extraction model is prepared for each topic. For example, the extraction unit 2040 extracts the keywords 20 from the sentence data 10 by using the keyword information associated with the selected target topic. In another example, the extraction unit 2040 extracts the keywords 20 from the sentence data 10 by inputting the sentence data 10 to the keyword extraction model associated with the selected target topic.

There are various ways of selecting the target topic. For example, the target topic is designated in advance by an administrator of the image generation apparatus 2000.

In another example, the target topic is designated by the user of the image generation apparatus 2000. In such a case, for example, the acquisition unit 2020 acquires information (hereinafter, topic information) representing the target topic, together with the sentence data 10.

The acquisition unit 2020 acquires the topic information in various ways. For example, the acquisition unit 2020 provides the user of the image generation apparatus 2000 with an input screen on which each of the target topic and the sentence data 10 can be input. The acquisition unit 2020 acquires the sentence data 10 and the topic information from the information input to the input screen.

For example, the input screen includes an input interface in which one of a plurality of topics prepared in advance can be selected. The acquisition unit 2020 handles a topic selected using the input interface as a target topic.

The sentence data 10 and the topic information may be stored in the storage unit in advance. In such a case, the acquisition unit 2020 acquires the sentence data 10 and the topic information from the storage unit.

In another example, the sentence data 10 and the topic information may be input to the image generation apparatus 2000 from another application.

The target topic may be estimated from the content of the sentence data 10. In such a case, for example, the extraction unit 2040 includes a machine learning model (hereinafter, topic model) trained in advance to estimate a topic of sentences in response to the input of the sentences. The extraction unit 2040 determines the target topic by inputting the sentence data 10 into the topic model.

Herein, in order to cause the image generation model 30 to generate the image data 40 by using the keyword 20, it is preferable that the keyword 20 is a word that can be understood by the image generation model 30 (in other words, a word that the image generation model 30 can correctly interpret). However, if the keyword 20 is a technical term rather than a common everyday term, the image generation model 30 may not be able to interpret the keyword 20 correctly.

Therefore, the extraction unit 2040 may replace the word extracted from the sentence data 10 with another word (hereinafter, referred to as a “replacement word”) that is presumed to be easier for the image generation model 30 to interpret, and handle the replacement word as the keyword 20.

The replacement of a word is performed using, for example, the keyword information described above. In such a case, the keyword information indicates a replacement word associated with a word that needs to be replaced among the words to be extracted from the sentence data 10.

As the replacement word, a word that is easier for the image generation model 30 to interpret is used. For example, the keyword information specifies, for each proper noun in the target topic, a broader term than the proper noun as the replacement word thereof.

Note that the keyword information may specify a plurality of replacement words in association with a single word. In such a case, extracting one word from the sentence data 10 means extracting a plurality of replacement words from the sentence data 10. For example, a plurality of words that play a key role in conveying the meaning of a technical term may be used as the plurality of replacement words associated with that technical term.

The keyword information including the replacement word is used, for example, as follows. The extraction unit 2040 detects words specified in the keyword information from the sentence data 10. The following processing is performed on each word detected from the sentence data 10. If the keyword information specifies no replacement word in association with the detected word, the extraction unit 2040 handles the detected word as the keyword 20 as it is. Meanwhile, if the keyword information specifies a replacement word in association with the detected word, the extraction unit 2040 handles the replacement word associated with the detected word as the keyword 20.

The keyword information may specify a word to be extracted from the sentence data 10 in association with text data (hereinafter, referred to as a “semantic text”) representing the meaning of that word. The semantic text can also be expressed as a descriptive text for a keyword.

The semantic text represents a sentence comprising words that can be easily interpreted by the image generation model 30. For example, the keyword information specifies, for each proper noun in the target topic, a descriptive text for the proper noun using general words as a semantic text for the proper noun.

The keyword information including the semantic text is used, for example, as follows. The extraction unit 2040 detects words specified in the keyword information from the sentence data 10. The following processing is performed on each word detected from the sentence data 10. If the keyword information specifies no semantic text in association with the detected word, the extraction unit 2040 handles the detected word as the keyword 20 as it is. Meanwhile, if the keyword information specifies a semantic text in association with the detected word, the extraction unit 2040 performs keyword detection on the semantic text associated with the detected word. Then, the extraction unit 2040 handles the word extracted from the semantic text by the keyword detection as the keyword 20. A method for extracting a keyword from the semantic text is similar to the method for extracting a keyword from the sentence data 10.

Here, the extraction unit 2040 may be configured to store a keyword once the keyword has been extracted from the semantic text corresponding to a certain word. By doing so, it is possible to avoid performing keyword extraction multiple times for the same semantic text.

For example, the keyword information is configured to specify a semantic text and a replacement word in association with a word to be extracted as a keyword. However, the keyword information in the initial state specifies the semantic text, while not specifying the replacement word.

If the keyword information specifies the replacement word in association with a word detected from the sentence data 10, the extraction unit 2040 handles the replacement word associated with the detected word as the keyword 20. Meanwhile, suppose that the keyword information specifies no replacement word in association with a word detected from the sentence data 10 while the keyword information specifies the semantic text in association with the detected word. In such a case, the extraction unit 2040 extracts a keyword from the semantic text, and handles the extracted keyword as the keyword 20. Furthermore, the extraction unit 2040 stores the keyword extracted from the semantic text in the keyword information as a replacement word in association with the detected word.

According to the above-described processing, it is not necessary to prepare a replacement word to be specified in the keyword information in advance. Therefore, the labor of preparing the replacement word is reduced. Further, it is also possible to avoid performing keyword extraction multiple times for a single semantic text.

### Generation of Image Data 40: S106

The generation unit 2060 generates the image data 40 by acquiring the image data 40 from the image generation model 30 by inputting the plurality of keywords 20 to the image generation model 30 (S106). It is possible to use, as the image generation model 30, any model trained in advance to output, in response to input of a plurality of words, one or more pieces of image data related to the plurality of words.

The generation unit 2060 may perform weighting on each of the keywords 20 extracted by the extraction unit 2040. In such a case, the generation unit 2060 inputs the plurality of keywords 20 and the weight of each of the keywords 20 to the image generation model 30. The image generation model 30 is trained in advance to generate image data in response to input of a plurality of words and a weight of each word.

The weight of each keyword 20 is represented by, for example, a rank. For example, the generation unit 2060 assigns a default weight (e.g., 0) to each keyword 20. Thereafter, the generation unit 2060 performs weighting on the keywords 20 by increasing or decreasing the weight of each of the keywords 20, based on one or more criteria.

The default weights may be the same for all of the keywords 20 or may vary for each keyword. For example, the default weight may be specified in the keyword information. The more important a word in the target topic is, the greater the default weight thereof is defined.

The criteria being used for weighting the keyword 20 will be described hereinafter.

### <<Criterion 1>>

The keyword 20 with a higher occurrence count in the sentence data 10 is more likely to be a more important word in the sentence data 10. Thus, for example, the weight of the keyword 20 is determined based on the occurrence count of the keyword 20 in the sentence data 10. Specifically, the generation unit 2060 assigns a larger weight to the keyword 20 as the occurrence count thereof in the sentence data 10 increases.

To this end, the generation unit 2060 determines the occurrence count of each keyword 20 in the sentence data 10. Then, the generation unit 2060 assigns a weight to each keyword 20 based on its occurrence count.

For example, a threshold value for determining whether to increase the weight of the keyword 20 is defined in advance. In such a case, when the occurrence count of the keyword 20 is equal to or greater than the threshold value, the generation unit 2060 adds a predetermined value (e.g., 1) to the weight of that keyword 20.

Herein, instead of the occurrence count of a keyword 20, a ratio of the occurrence count of a keyword 20 to the total number of keywords 20 detected from the sentence data 10 may be used. For example, it is assumed that the occurrence count of the keyword “e-mail” is n, while the total number of keywords 20 detected from the sentence data 10 is N. In such a case, the generation unit 2060 increases the weight of the keyword e-mail when n/N is equal to or greater than the threshold value.

The threshold value may be defined in multiple stages. For example, it is assumed that two threshold values Th1 and Th2 are defined, where Th2>Th1. In such a case, if the occurrence count of a keyword 20 is Th2 or more, the generation unit 2060 increases the weight of the keyword 20 by A2. Furthermore, if the occurrence count of the keyword 20 is smaller than Th2 and is equal to or greater than Th1, the generation unit 2060 increases the weight of the keyword 20 by A1, where A2>A1.

Note that the generation unit 2060 may decrease the weight of the keyword 20 if the occurrence count of the keyword 20 is small.

### <<Criterion 2>>

When the keyword 20 is not a polysemous word and is related to the target topic, it can be predicted that the importance of the keyword 20 is relatively high. Therefore, the generation unit 2060 increases the weight of the keyword 20 by a predetermined value (e.g., 1) if the keyword 20 is not a polysemous word and is related to the target topic.

Meanwhile, if the keyword 20 is a polysemous word and is not related to the target topic, it is considered that the importance of the keyword 20 is relatively low. Therefore, the generation unit 2060 decreases the weight of the keyword 20 by a predetermined value (e.g., 1) if the keyword 20 is a polysemous word and is not related to the target topic.

Here, whether the keyword 20 is a polysemous word can be determined using, for example, dictionary data. As the dictionary data, it is preferable to use data from a dictionary (such as a language dictionary or an encyclopedia) that comprehensively indicates various meanings for each word. If the dictionary data indicates a plurality of meanings for the keyword 20, the generation unit 2060 determines that the keyword 20 is a polysemous word. On the other hand, if the dictionary data indicates only one meaning for the keyword 20, the generation unit 2060 determines that the keyword 20 is not a polysemous word.

Whether the keyword 20 is related to the target topic can be determined using, for example, dictionary data prepared for each topic. For example, it is assumed that the target topic is cyber security. In such a case, dictionary data indicating words related to cyber security is used. If the dictionary data associated with the target topic indicates the keyword 20, the generation unit 2060 determines that the keyword 20 is related to the target topic. On the other hand, if the dictionary data associated with the target topic does not indicates the keyword 20, the generation unit 2060 determines that the keyword 20 is not related to the target topic.

Note that the topic used for the determination of the increase in the weight, the determination of the decrease in the weight, or both may be a topic (hereinafter, referred to as a “higher-level topic”) that represents a higher-level topic of the target topic. For example, if the target topic is cyber security, a higher-level topic such as information technology (IT) may be used.

In a case where the higher-level topic is used for the determination of the increase in the weight, the generation unit 2060 increases the weight of the keyword 20 by a predetermined value if the keyword 20 is not a polysemous word and is related to the higher-level topic. In a case where the higher-level topic is used for the determination of the decrease in the weight, the generation unit 2060 decreases the weight of the keyword 20 by a predetermined value if the keyword 20 is a polysemous word and is not related to the higher-level topic.

### <<Adjustment Based on Occurrence Order>>

The generation unit 2060 may adjust the weight of each keyword 20, which has been determined by the one or more of the aforementioned criteria, according to the occurrence order of the keyword 20 in the sentence data 10. For example, the adjustment based on the occurrence order may be applied among a plurality of keywords 20 that have been assigned the same weight. In such a case, for example, the generation unit 2060 adds a value to the weight of each keyword 20 among the plurality of keywords 20 assigned the same weight, where the value increases as the keyword 20 appears earlier in the sentence data 10 and is less than 1 at maximum. By doing so, it is possible to introduce differences in importance among a plurality of keywords 20 that are assigned the same rank as a weight.

### Output of Result

The image generation apparatus 2000 outputs information (hereinafter, referred to as “output information”) representing the result of the processing. The contents of the output information are various. For example, the output information includes the image data 40. In another example, the output information may be a document or an image generated by arranging the sentence data 10 and the image data 40 at predetermined positions. For example, if the sentence data 10 is a security report, the output information may include a document file or the like containing a security report to which an image associated with the security report is attached.

The output information may be output in various manners. For example, the image generation apparatus 2000 stores the output information into any storage unit. In another example, the image generation apparatus 2000 outputs the output information to any display device to display the content of the output information on the display device. In another example, if the sentence data 10 is input from another application to the image generation apparatus 2000, the image generation apparatus 2000 may output the output information to the application.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

In the present disclosure, the program includes instructions (or software code) that, when loaded into a computer, cause the computer to perform one or more of the functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Some or all of the above-described example embodiments may be described as the following supplementary notes, but are not limited thereto.

### (Supplementary Note 1)

An image generation apparatus comprising:
at least one memory that is configured to store instructions; and
at least one processor that is configured to execute the instructions to: acquire sentence data;
extract a plurality of keywords from the sentence data; and
generate an image related to the sentence data by inputting the plurality of keywords to an image generation model.

### (Supplementary Note 2)

The image generation apparatus according to supplementary note 1,
wherein the extraction of the plurality of keywords includes:
acquiring keyword information that specifies a semantic text representing a meaning of a word for one or more words to be extracted as the keywords; and
when the sentence data includes a word associated with the semantic text in the keyword information, extracting one or more of the keywords from the semantic text corresponding to the associated word.

### (Supplementary Note 3)

The image generation apparatus according to supplementary note 1,
wherein the extraction of the plurality of keywords includes:
acquiring keyword information that specifies a replacement word for one or more words to be extracted as the keywords; and
when the sentence data includes a word associated with the replacement word in the keyword information, extracting the replacement word corresponding to the associated word as the keyword.

### (Supplementary Note 4)

The image generation apparatus according to supplementary note 1,
wherein the generation of the image includes:
determining a weight of each of the keywords, based on a feature of each of the keywords; and
inputting each of the keywords and the weight of each of the keywords to the image generation model.

### (Supplementary Note 5)

The image generation apparatus according to supplementary note 4, wherein the generation of the image includes determining a weight of each of the keywords based on an occurrence count of each of the keywords in the sentence data.

### (Supplementary Note 6)

The image generation apparatus according to supplementary note 4, wherein the generation of the image includes increasing a weight of the keyword when the keyword is not a polysemous word and is related to a specific topic.

### (Supplementary Note 7)

The image generation apparatus according to supplementary note 4, wherein the generation of the image includes decreases a weight of the keyword when the keyword is a polysemous word and is not related to a specific topic.

### (Supplementary Note 8)

An image generation method to be executed by one or more computers, comprising:
acquiring sentence data;
extracting a plurality of keywords from the sentence data; and
generating an image related to the sentence data by inputting the plurality of keywords to an image generation model.

### (Supplementary Note 9)

The image generation method according to supplementary note 8,
wherein the extraction of the plurality of keywords includes:
acquiring keyword information that specifies a semantic text representing a meaning of a word for one or more words to be extracted as the keywords; and
when the sentence data includes a word associated with the semantic text in the keyword information, extracting one or more of the keywords from the semantic text corresponding to the associated word.

### (Supplementary Note 10)

A program that causes one or more computers to execute:
acquiring sentence data;
extracting a plurality of keywords from the sentence data; and
generating an image related to the sentence data by inputting the plurality of keywords to an image generation model.

Some or all of the elements (e.g., configurations and functions) described in supplementary note 2 depending on supplementary note 1 may also be dependent on supplementary note 10. In addition, some or all of the elements (e.g., configurations and functions) described in supplementary notes 3 to 7 depending on supplementary note 1 may also be dependent on supplementary notes 9 and 10 in dependency similar to supplementary notes 3 to 7. Some or all of the elements described in any supplementary note may be applied to various hardware, software, recording means for recording software, systems, and methods.

What is claimed is:

1. An image generation apparatus comprising:
at least one memory that is configured to store instructions; and
at least one processor that is configured to execute the instructions to:
acquire sentence data;
extract a plurality of keywords from the sentence data; and
generate an image related to the sentence data by inputting the plurality of keywords to an image generation model.

2. The image generation apparatus according to claim 1,
wherein the extraction of the plurality of keywords includes:
acquiring keyword information that specifies a semantic text representing a meaning of a word for one or more words to be extracted as the keywords; and
when the sentence data includes a word associated with the semantic text in the keyword information, extracting one or more of the keywords from the semantic text corresponding to the associated word.

3. The image generation apparatus according to claim 1,
wherein the extraction of the plurality of keywords includes:
acquiring keyword information that specifies a replacement word for one or more words to be extracted as the keywords; and
when the sentence data includes a word associated with the replacement word in the keyword information, extracting the replacement word corresponding to the associated word as the keyword.

4. The image generation apparatus according to claim 1,
wherein the generation of the image includes:
determining a weight of each of the keywords, based on a feature of each of the keywords; and
inputting each of the keywords and the weight of each of the keywords to the image generation model.

5. The image generation apparatus according to claim 4, wherein the generation of the image includes determining a weight of each of the keywords based on an occurrence count of each of the keywords in the sentence data.

6. The image generation apparatus according to claim 4, wherein the generation of the image includes increasing a weight of the keyword when the keyword is not a polysemous word and is related to a specific topic.

7. The image generation apparatus according to claim 4, wherein the generation of the image includes decreases a weight of the keyword when the keyword is a polysemous word and is not related to a specific topic.

8. An image generation method to be executed by one or more computers, comprising:
acquiring sentence data;
extracting a plurality of keywords from the sentence data; and
generating an image related to the sentence data by inputting the plurality of keywords to an image generation model.

9. The image generation method according to claim 8,
wherein the extraction of the plurality of keywords includes:
acquiring keyword information that specifies a semantic text representing a meaning of a word for one or more words to be extracted as the keywords; and
when the sentence data includes a word associated with the semantic text in the keyword information, extracting one or more of the keywords from the semantic text corresponding to the associated word.

10. The image generation method according to claim 8,
wherein the extraction of the plurality of keywords includes:
acquiring keyword information that specifies a replacement word for one or more words to be extracted as the keywords; and
when the sentence data includes a word associated with the replacement word in the keyword information, extracting the replacement word corresponding to the associated word as the keyword.

11. The image generation method according to claim 8,
wherein the generation of the image includes:
determining a weight of each of the keywords, based on a feature of each of the keywords; and
inputting each of the keywords and the weight of each of the keywords to the image generation model.

12. The image generation method according to claim 11, wherein the generation of the image includes determining a weight of each of the keywords based on an occurrence count of each of the keywords in the sentence data.

13. The image generation method according to claim 11, wherein the generation of the image includes increasing a weight of the keyword when the keyword is not a polysemous word and is related to a specific topic.

14. The image generation method according to claim 11, wherein the generation of the image includes decreases a weight of the keyword when the keyword is a polysemous word and is not related to a specific topic.

15. A non-transitory computer-readable medium storing a program that causes one or more computers to execute:
acquiring sentence data;
extracting a plurality of keywords from the sentence data; and
generating an image related to the sentence data by inputting the plurality of keywords to an image generation model.

16. The medium according to claim 15,
wherein the extraction of the plurality of keywords includes:
acquiring keyword information that specifies a semantic text representing a meaning of a word for one or more words to be extracted as the keywords; and
when the sentence data includes a word associated with the semantic text in the keyword information, extracting one or more of the keywords from the semantic text corresponding to the associated word.

17. The medium according to claim 15,
wherein the extraction of the plurality of keywords includes:
acquiring keyword information that specifies a replacement word for one or more words to be extracted as the keywords; and
when the sentence data includes a word associated with the replacement word in the keyword information, extracting the replacement word corresponding to the associated word as the keyword.
